(19) United States
(12) Patent Application Publication
(10) Pub. No.: US 2018/0240023 A1
(43) Pub. Date: Aug. 23, 2018

(54) METHODS AND SYSTEMS FOR SELECTING TARGETED CONTENT BY MACHINE LEARNING ALGORITHM

(71) Applicant: YANDEX EUROPE AG, Luzern (CH)

(72) Inventors: Roman Kirillovitch IVANOV, Moscow (RU); Artem Alekseevich PAPILOV, Moscow (RU); Dmitry Sergeevich Timko, Moscow (RU)

(21) Appl. No.: 15/700,897

(22) Filed: Sep. 11, 2017

(30) Foreign Application Priority Data
Feb. 22, 2017 (RU) 2017106033

(51) Int. Cl. G06N 5/04; G06F 17/30; G06N 99/00; G06Q 30/02

(52) U.S. Cl. CPC G06N 5/04; G06F 17/30887; G06F 17/30896; G06F 17/30867; G06Q 30/0277; G06F 17/3053; G06N 99/005; G06Q 30/0256; G06F 17/30528

(57) ABSTRACT

Methods and systems for selecting targeted content by a machine learning algorithm (MLA) comprising: receiving and storing as a negative training example a first set of indications of blocked targeted content having been triggered by a user, each indication including a plurality of attributes of a blocked targeted content, receiving and storing as a positive training example a second set of indications of targeted content, each indication of the second set of indications comprising a plurality of attributes of a targeted content, training the MLA based on the positive training example and the negative training example to determine a type of to-be-selected targeted content, the type being one of a positive or a negative targeted content, responsive to receiving to-be-selected targeted content, determining based on the plurality of attributes of the targeted content the type of the targeted content and causing the electronic device to block negative type targeted content.

### CROSS-REFERENCE

The present application claims priority to Russian Patent Application No. 2017106033, filed on Feb. 22, 2017, entitled “Methods And Systems For Selecting Targeted Content By Machine Learning Algorithm,” the entirety of which is incorporated herein by reference.

### FIELD

The present technology relates to machine-learning algorithms and more specifically to methods and systems for selecting targeted content by a machine learning algorithm.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of electronic devices (desktop, laptop, notebook, smartphone, tablets and the like) to have access to rich content (like images, audio, video, animation, and other multimedia content from such networks).

The volume of available information through various Internet resources has grown exponentially in the past couple of years. Several solutions have been developed in order to allow a typical user to find the information that the user is looking for. One example of such a solution is a search engine. Examples of the search engines include Google™ search engine, Yandex™ search engine, Yahoo!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the tanked list of search results).

The search engines typically provide a good search tool for a search query that the user knows a priori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a Flipboard™ recommending system, which system aggregates and recommends content from various social networks. The Flipboard™ recommending system presents the uncovered content in a “magazine style” format, where the user can “flip” through the pages with the recommended/aggregated content. The recommending system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content.

U.S. Pat. No. 8,429,012 issued Apr. 23, 2013 to Wright et al. teaches a method and system for using estimated ad qualities for ad filtering, ranking and promotion. A system obtains a first parameter (QP1) associated with a quality of an advertisement among multiple advertisements, where the first quality parameter (QP1) does not include a click through rate (CTR). The system functionally combines the first quality parameter (QP1) with at least one other parameter and uses the functional combination to filter, rank or promote the advertisement among the multiple advertisements.

U.S. Pat. No. 8,352,499 issued Jan. 8, 2013 to Bharat et al. teaches serving advertisements using user request information and user information. Ads are scored using, at least, user information and information associated with a user request, such as a search query or a document request. The scores may be used in determining whether to serve ads, how to serve ads, to order ads, to filter ads, etc. Items of user information, request-associated information, and/or ad information can be weighted based on previous uses of such information in the serving of ads and the performance of those served ads.

For the foregoing reasons, there is a need for methods and systems for selecting targeted content to a user.

### SUMMARY

Embodiments of the present technology have been developed based on developers' appreciation of at least one technical problem associated with the prior art solutions.

The present technology arises from an observation made by the developer(s) that users may directly block unwanted targeted content via their electronic devices, and the information from the blocked targeted content may be used to train a machine learning algorithm. Such a method may not only allow to save computational resources on a user's electronic device or on a server, but may also employ the users as assessors to label targeted content, therefore providing a continuous supply of training data to the machine learning algorithm.

The present technology arises from an observation made by the developer(s) that information about blocked targeted content gathered by the machine learning algorithm may also be used to send feedback to providers of targeted content, therefore allowing to improve the relevancy and quality of targeted content presented to a user.

Therefore, inventor(s) have devised method and systems for selecting targeted content by a machine learning algorithm.

In accordance with a first broad aspect of the present technology, there is provided a method for selecting targeted content by a machine learning algorithm (MLA), the method executable on a server, the server connected to a plurality of electronic devices via a communication network, the method comprising: receiving, from the plurality of electronic devices, a first set of indications of blocked targeted content, each indication of the first set of indications having been triggered by a user of a electronic device of the plurality of electronic devices, each indication including a plurality of attributes of a blocked targeted content, the blocked targeted content having been displayed with a first resource on the electronic device; storing, by the server, the plurality of attributes of the blocked targeted content as a negative training example; receiving a second set of indications of targeted content, each indication of the second set of indications comprising a plurality of attributes of a targeted content, the targeted content having been displayed with a second resource on a electronic device; storing, by the server, the plurality of attributes of the targeted content as a positive training example; training the MLA based on the positive training example and the negative training example to determine a type of a to-be-selected targeted content based on the plurality of attributes of the targeted content, the type being one of a positive targeted content or a negative targeted content; responsive to receiving, from a content provider, the to-be-selected targeted content to be shown to a user of a electronic device of the plurality of electronic devices accessing a resource: determining, by the MLA, based on the plurality of attributes of the targeted content, the type of the targeted content; and responsive to the type of targeted content being the negative targeted content, causing the electronic device to block the targeted content.

In some embodiments, the method further comprises: responsive to the type of targeted content being the positive targeted content, allowing the targeted content to be displayed on the electronic device.

In some embodiments, wherein each indication of the first set of indications of blocked targeted content and each indication of the second set of indications of targeted content further comprises respectively a plurality of attributes of the first resource and the second resource with which the targeted content was displayed with, wherein the storing comprises storing the plurality of attributes of the first resource and the second resource and wherein the training and the determining are further based on the plurality of attributes of the first resource and the second resource.

In some embodiments, wherein the plurality of attributes of the targeted content being stored as a positive training example is the plurality of attributes of targeted content not having been blocked by a user accessing the second resource.

In some embodiments, each indication of the first set of indications of blocked targeted content and each indication of the second set of indications of targeted content further comprises a plurality of attributes of the respective user, and wherein the training and the determining are further based on the plurality of attributes of the respective user.

In some embodiments, the second set of indications of targeted content is received from the content provider.

In some embodiments, the second set of indications of targeted content is received from the plurality of electronic devices.

In some embodiments, each indication of the first set of indications of blocked targeted content and each indication of the second set of indications of targeted content further comprises a plurality of attributes of the respective electronic device, and wherein the training and the determining are further based on the plurality of attributes of the respective electronic device.

In some embodiments, each indication has been triggered by the user of the electronic device pressing a button in a browser application of the electronic device to block targeted content.

In some embodiments, the plurality of attributes of the targeted content and the plurality of attributes of the blocked targeted content comprise at least one of: a size of the targeted content, a location of the targeted content on the resource, a source associated with the targeted content, a presence of audio in the targeted content, a presence of animations in the targeted content, a HTML attribute of the targeted content.

In some embodiments, wherein the plurality of attributes of the resource comprises at least one of: a uniform resource locator (URL) of the resource, a title of the resource, a text of the resource, a HTML attribute of the resource, a screenshot of the resource.

In some embodiments, wherein the plurality of attributes of the user comprises at least one of: a unique identifier associated with the user of the electronic device, a user agent associated with the user of the electronic device, a user profile associated with the user of the electronic device.

In some embodiments, wherein the plurality of attributes of the electronic device comprises at least one of: an IP address of the electronic device, an identifier associated with the electronic device, properties of the electronic device, a cookie located on the electronic device.

In some embodiments, wherein after training the MLA based on the positive training example and the negative training example to determine the type of the targeted content, the method further comprises sending, to each electronic device of the plurality of electronic devices the MLA, and wherein the receiving, the determining and the causing the electronic device to block the targeted content are executed on the electronic device.

In some embodiments, wherein the training the MLA to determine the type of the targeted content comprises comparing the plurality of attributes of the targeted content and the associated plurality of attributes of the resource.

In some embodiments, wherein prior to determining by the MLA the type of the targeted content, the method further comprises: acquiring a list of blocked targeted content; responsive to the targeted content received from the content provider being part of the list of blocked targeted content, causing the electronic device to block the targeted content.

In some embodiments, wherein the list of blocked targeted content is received from the electronic device.

In some embodiments, the list of blocked targeted content is acquired from a database located on the server.

In some embodiments, the method further comprises: receiving, from a user of the plurality of electronic devices, an indication to block a specific set of targeted content, the indication having been triggered by the user of the electronic device pressing a button in a browser application, the specific set of targeted content being associated with a specific plurality of attributes; responsive to receiving, from the content provider connected to the server, a targeted content to be shown to the user of the electronic device of the plurality of electronic devices accessing a resource: determining if the plurality of attributes of the targeted content matches at least in part the specific plurality of attributes; and responsive to the plurality of attributes of the targeted content matching at least in part the specific plurality of attributes, causing the electronic device to block the targeted content.

In some embodiments, the method further comprises: receiving, from a user of the plurality of electronic devices, an indication to block all targeted content, the indication having been triggered by the user of the electronic device pressing a button in a browser application; and sending, by the server, instructions causing the electronic device to block all targeted content displayed by the browser application.

In accordance with a second broad aspect of the present technology, there is provided a system for selecting targeted content by a machine learning algorithm (MLA), the system connected to a plurality of electronic devices via a communication network, the system comprising: a processor; a non-transitory computer-readable medium comprising instructions, the processor; upon executing the instructions, being configured to cause: receiving, from the plurality of electronic devices, a first set of indications of blocked targeted content, each indication of the first set of indications having been triggered by a user of an electronic device of the plurality of electronic devices, each indication including a plurality of attributes of a blocked targeted content, the blocked targeted content having been displayed with a first resource on the electronic device; storing the plurality of attributes of the blocked targeted content as a negative training example; receiving a second set of indications of targeted content, each indication of the second set of indications comprising a plurality of attributes of a targeted content, the targeted content having been displayed with a second resource on a electronic device; storing the plurality of attributes of the targeted content as a positive training example; training the MLA based on the positive training example and the negative training example to determine a type of a to-be-selected targeted content based on the plurality of attributes of the targeted content, the type being one of a positive targeted content or a negative targeted content; responsive to receiving, from a content provider, the to-be-selected targeted content to be shown to a user of a electronic device of the plurality of electronic devices accessing a resource: determining, by the MLA, based on the plurality of attributes of the targeted content, the type of the targeted content; and responsive to the type of targeted content being the negative targeted content, causing the electronic device to block the targeted content.

In some embodiments, the system further comprises: responsive to the type of targeted content being the positive targeted content, allowing the targeted content to be displayed on the electronic device; In some embodiments, wherein indication of the first set of indications of blocked targeted content and each indication of the second set of indications of targeted content further comprises a plurality of attributes of the resource with which the targeted content was displayed with, wherein the storing comprises storing the plurality of attributes of the resource and wherein the training and the determining are further based on the plurality of attributes of the resource.

In some embodiments, the targeted content of the plurality of attributes indications of the targeted content being stored as a positive training example is targeted content not having been blocked by a user accessing the resource.

In some embodiments, each indication of the first set of indications of blocked targeted content and each indication of the second set of indications of targeted content further comprises a plurality of attributes of the respective user, and wherein the training and the determining are further based on the plurality of attributes of the respective user.

In some embodiments, the second set of indications of targeted content is received from the content provider.

In some embodiments, the second set of indications of targeted content is received from the plurality of electronic devices.

In some embodiments, each indication of the first set of indications of blocked targeted content and each indication of the second set of indications of targeted content further comprises a plurality of attributes of the respective electronic device, and wherein the training and the determining are further based on the plurality of attributes of the respective electronic device.

In some embodiments, each indication has been triggered by the user of the electronic device pressing a button in a browser application of the electronic device to block targeted content.

In some embodiments, the plurality of attributes of the targeted content and the plurality of attributes of the blocked targeted content comprise at least one of: a size of the targeted content, a location of the targeted content on the resource, a source associated with the targeted content, a presence of audio in the targeted content, a presence of animations in the targeted content, a HTML attribute of the targeted content.

In some embodiments, the plurality of attributes of the resource comprises at least one of: a uniform resource locator (URL) of the resource, a title of the resource, a text of the resource, a HTML attribute of the resource, a screenshot of the resource.

In some embodiments, the plurality of attributes of the user comprises at least one of: a unique identifier associated with the user of the electronic device, a user agent associated with the user of the electronic device, a user profile associated with the user of the electronic device.

In some embodiments, the plurality of attributes of the electronic device comprises at least one of: an IP address of the electronic device, an identifier associated with the electronic device, properties of the electronic device, a cookie located on the electronic device.

In some embodiments, after training the MLA based on the positive training example and the negative training example to determine the type of the targeted content, the method further comprises sending, to each electronic device of the plurality of electronic devices the MLA, and wherein the receiving, the determining and the causing the electronic device to block the targeted content are executed on the electronic device.

In some embodiments, the training the MLA to determine the type of the targeted content comprises comparing the plurality of attributes of the targeted content and the associated plurality of attributes of the resource.

In some embodiments, wherein prior to determining by the MLA the type of the targeted content, the method further comprises: acquiring a list of blocked targeted content; responsive to the targeted content received from the content provider being part of the list of blocked targeted content, causing the electronic device to block the targeted content.

In some embodiments, the list of blocked targeted content is received from the electronic device.

In some embodiments, the list of blocked targeted content is acquired from a database located on the server.

In some embodiments, the system further comprises: receiving, from a user of the plurality of electronic devices, an indication to block a specific set of targeted content, the indication having been triggered by the user of the electronic device pressing a button in a browser application, the specific set of targeted content being associated with a specific plurality of attributes; responsive to receiving, from the content provider connected to the server, a targeted content to be shown to the user of the electronic device of the plurality of electronic devices accessing a resource: determining if the plurality of attributes of the targeted content matches at least in part the specific plurality of attributes; and responsive to the plurality of attributes of the targeted content matching at least in part the specific plurality of attributes, causing the electronic device to block the targeted content.

In some embodiments, the system further comprises: receiving, from a user of the plurality of electronic devices, an indication to block all targeted content, the indication having been triggered by the user of the electronic device pressing a button in a browser application; and sending, by the server, instructions causing the electronic device to block all targeted content displayed by the browser application.

In the context of the present specification, a “server” is a computer program that is running on appropriate hardware and is capable of receiving requests (e.g. from electronic devices) over a network, and carrying out those requests, or causing those requests to be carried out. The hardware may be implemented as one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “electronic device” is any computer hardware that is capable of running software appropriate to the relevant task at hand. In the context of the present specification, the term “electronic device” implies that a device can function as a server for other electronic devices and electronic devices, however it is not required to be the case with respect to the present technology. Thus, some (non-limiting) examples of electronic devices include personal computers (desktops, laptops, netbooks, etc.), smartphones, and tablets, as well as network equipment such as routers, switches, and gateways. It should be understood, that in the present context the fact that the device functions as an electronic device does not mean that it cannot function as a server for other electronic devices. The use of the expression “an electronic device” does not preclude multiple electronic devices being used in receiving/sending, carrying out or causing to be carried out any task or request, or the consequences of any task or request, or steps of any method described herein.

In the context of the present specification, “electronic device” is any computer hardware that is capable of running software appropriate to the relevant task at hand. In the context of the present specification, in general the term “electronic device” is associated with a user of the electronic device. Thus, some (non-limiting) examples of electronic devices include personal computers (desktops, laptops, netbooks, etc.), smartphones, and tablets, as well as network equipment such as routers, switches, and gateways It should be noted that a device acting as a electronic device in the present context is not precluded from acting as a server to other electronic devices. The use of the expression “a electronic device” does not preclude multiple electronic devices being used in receiving/sending, carrying out or causing to be carried out any task or request, or the consequences of any task or request, or steps of any method described herein.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “software component” is meant to include software (appropriate to a particular hardware context) that is both necessary and sufficient to achieve the specific function(s) being referenced.

In the context of the present specification, the expression “computer information storage media” (also referred to as “storage media”) is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage media, including two or more media components of a same type and/or two or more media components of different types.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first database” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware components, in other cases they may be different software and/or hardware components.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 is an illustration of components and features of an electronic device implemented in accordance with a non-limiting embodiment of the present technology.

FIG. 2 is an illustration of a communication system that includes the electronic device of FIG. 1, the system implemented in accordance with a non-limiting embodiment of the present technology.

FIG. 3 is an illustration of the electronic device of FIG. 1 executing a browser application implementing a first level of targeted content selection implemented in accordance with a non-limiting embodiment of the present technology.

FIG. 4 is an illustration of the electronic device executing a browser application implementing a second level of targeted content selection implemented in accordance with a non-limiting embodiment of the present technology.

FIG. 5 is an illustration of electronic device executing a browser application implementing a third level of targeted content selection implemented in accordance with a non-limiting embodiment of the present technology.

FIG. 6 is an illustration of the electronic device executing a browser application implementing a fourth level of targeted content selection implemented in accordance with a non-limiting embodiment of the present technology.

FIG. 7 is an illustration of four levels of selection of targeted content implemented in accordance with a non-limiting embodiment of the present technology.

FIG. 8 is an illustration of a machine learning component for the selection of targeted content implemented in accordance with a non-limiting embodiment of the present technology.

FIG. 9 is a flow-chart illustration of a method for selecting targeted content implemented in accordance with a non-limiting embodiment of the present technology.

FIG. 10 is a flow-chart illustration of a method for selecting targeted content implemented in accordance with a non-limiting embodiment of the present technology.

FIG. 11 is a flow-chart illustration of a method for selecting targeted content implemented in accordance with a non-limiting embodiment of the present technology.

FIG. 12 is a flow-chart illustration of a method for selecting targeted content implemented in accordance with a non-limiting embodiment of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

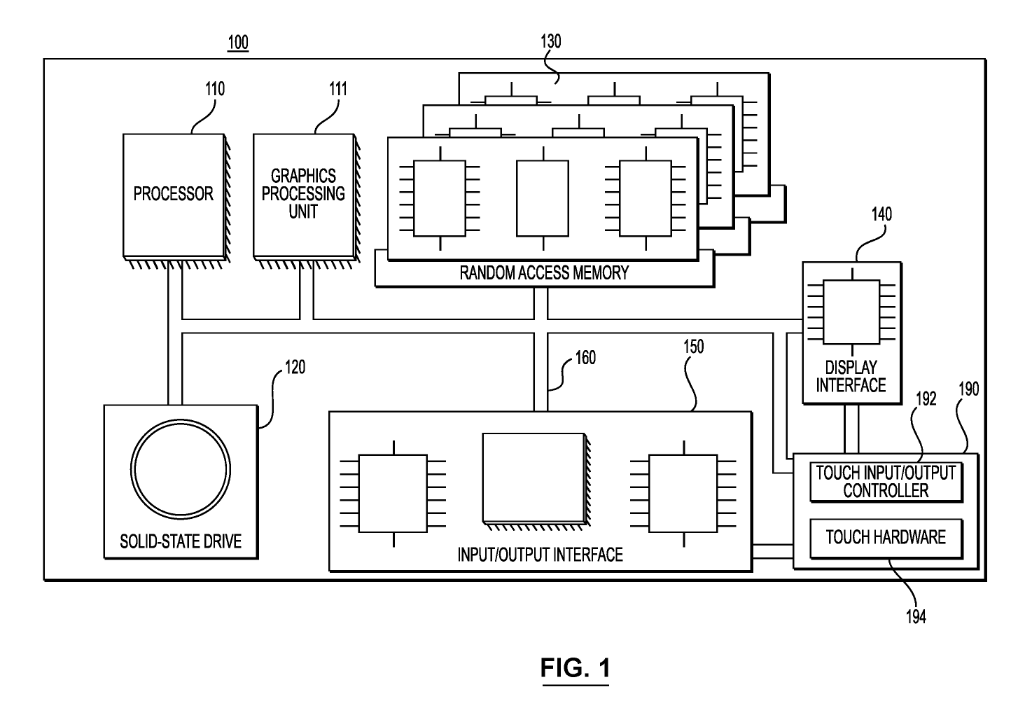

Referring to FIG. 1, there is shown a first electronic device 100 suitable for use with some implementations of the present technology, the first electronic device 100 comprising various hardware components including one or more single or multi-core processors collectively represented by processor 110, a graphics processing unit (GPU) 111, a solid-state drive 120, a random access memory 130, a display interface 140, and an input/output interface 150.

Communication between the various components of the first electronic device 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

According to implementations of the present technology, the solid-state drive 120 stores program instructions suitable for being loaded into the random access memory 130 and executed by the processor 110 and/or the GPU 111. For example, the program instructions may be part of a library or an application.

The first electronic device 100 may be a server, a desktop computer, a laptop computer, a tablet, a smartphone, a personal digital assistant or any device that may be configured to implement the present technology, as should be understood by a person skilled in the art.

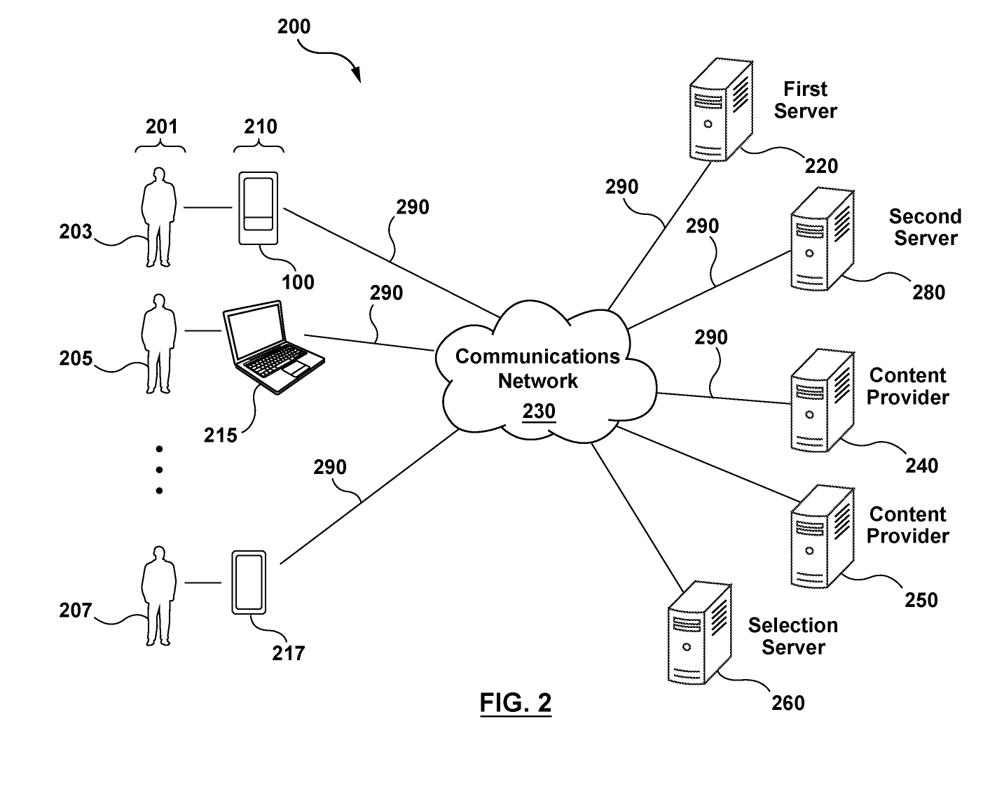

Now turning to FIG. 2, a communication system 200 is illustrated in accordance with an embodiment of the present technology. The communication system 200 comprises a plurality of users 201, the plurality of users 201 comprising a first user 203, a second user 205 and a third user 207 respectively associated with the first electronic device 100, a second electronic device 215 and a third electronic device 217, coupled to a communications network 280 via a communication link 290. The second electronic device 215 may be implemented as a laptop and the third electronic device 217 may be implemented as a smartphone. In some non-limiting embodiments of the present technology, the communications network 280 can be implemented as the Internet. In other embodiments of the present technology, the communications network 280 can be implemented differently, such as any wide-area communications network, local-area communications network, a private communications network and the like.

How the communication link 290 is implemented is not particularly limited and will depend on how the first electronic device 100, the second electronic device 215 and the third electronic device 217 are implemented. Merely as an example and not as a limitation, in those embodiments of the present technology where at least one of the first electronic device 100, the second electronic device 215 and the third electronic device 217 is implemented as a wireless communication device (such as a smart-phone), the communication link 290 can be implemented as a wireless communication link (such as but not limited to, a 3G communications network link, a 4G communications network link, a Wireless Fidelity, or WiFi® for short, Bluetooth® and the like). In those examples, where the first electronic device 100 is implemented as a notebook computer, the communication link 290 can be either wireless (such as the Wireless Fidelity, or WiFi® for short, Bluetooth® or the like) or wired (such as an Ethernet based connection).

It should be expressly understood that implementations for the first electronic device 100, the second electronic device 215 and the third electronic device 217, the communication link 290 and the communications network 280 are provided for illustration purposes only. As such, those skilled in the art will easily appreciate other specific implementational details for the first electronic device 100, the second electronic device 215, the third electronic device 217, the communication link 290 and the communications network 280. As such, by no means, examples provided herein above are meant to limit the scope of the present technology.

Also coupled to the communications network is a first server 220, a second server 230, a first content provider 240, a second content provider 250 and a selection server 260. The first server 220, the second server 230, the first content provider 240, the second content provider 250 and the selection server 260 can all be implemented as conventional computer servers. In an example of an embodiment of the present technology, the first server 220, the second server 230, the first content provider 240, the second content provider 250 and the selection server 260 can be implemented as a Dell™ PowerEdge™ Server running the Microsoft™ Windows Server™ operating system. Needless to say, the first server 220, the second server 230, the first content provider 240, the second content provider 250 and the selection server 260 can be implemented in any other suitable hardware and/or software and/or firmware or a combination thereof. In the depicted non-limiting embodiment of present technology, the first server 220, the second server 230, the first content provider 240, the second content provider 250 and the selection server 260 are each independent servers. In alternative non-limiting embodiments of the present technology, the functionality of each one of the first server 220, the second server 230, the first content provider 240, the second content provider 250 and the selection server 260 may be distributed and may be implemented via multiple servers (not depicted).

In the context of the present technology, the selection server 260 may implement in part the methods and system described herein, and may act as a proxy between the plurality of electronic devices 210 and the first server 220, the second server 230, the first content provider 240 and the second content provider 250. The first server 220 and the second server 230 may each host a plurality of resources.

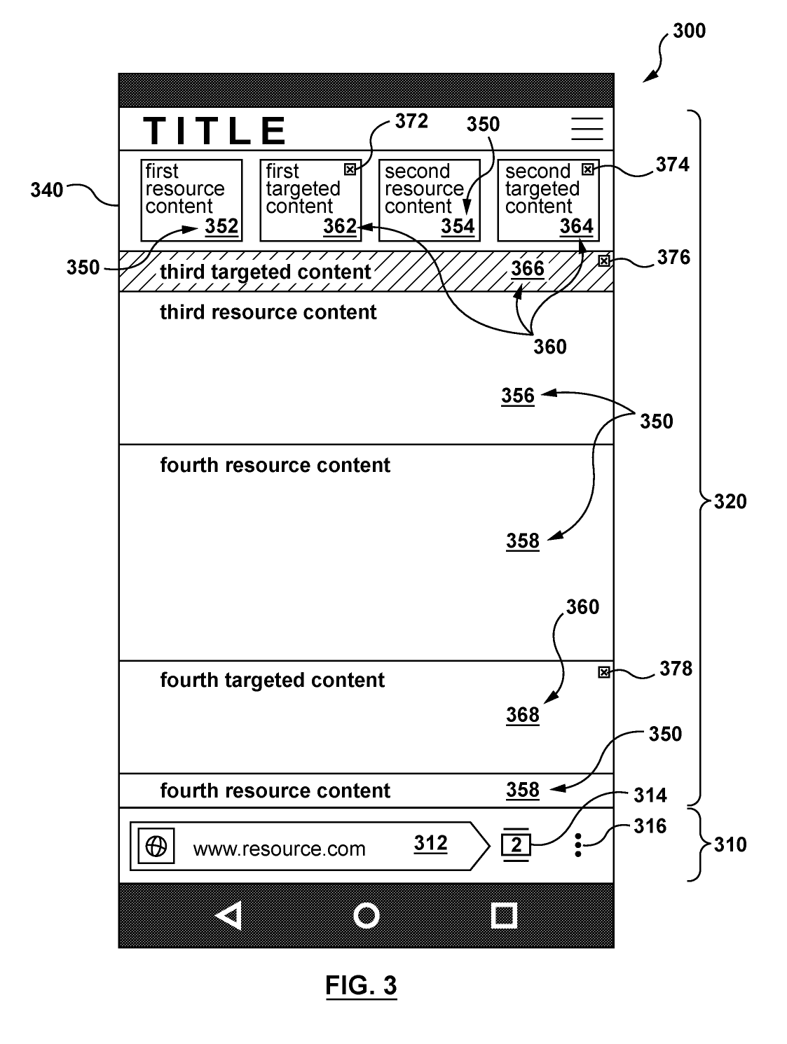

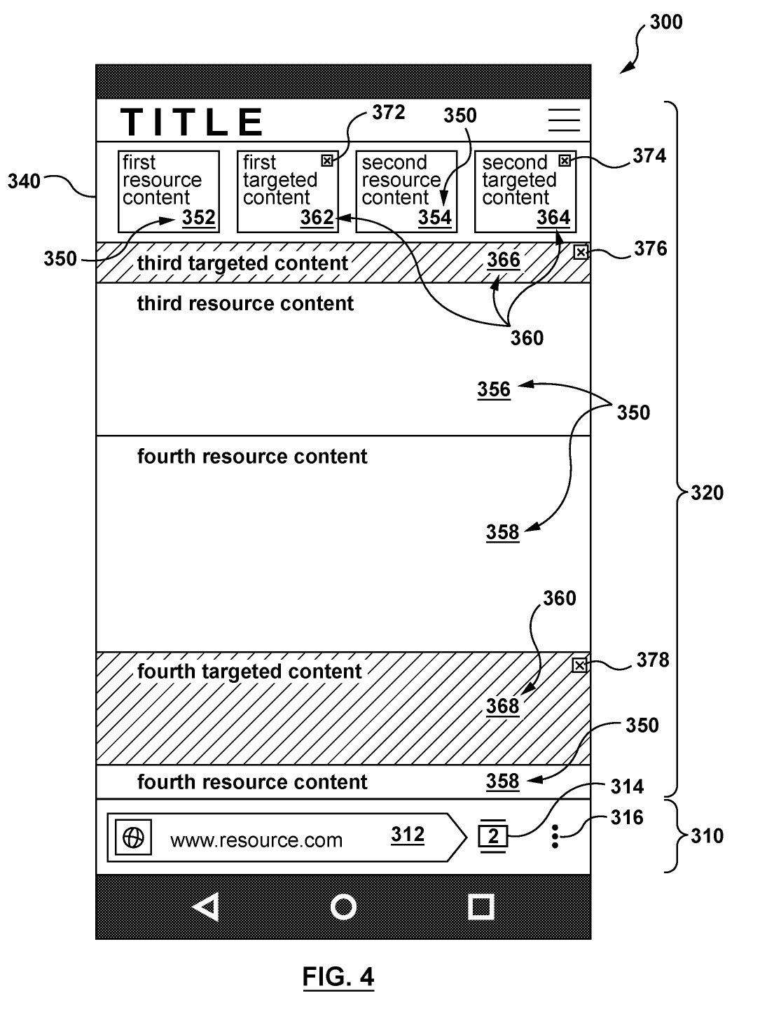

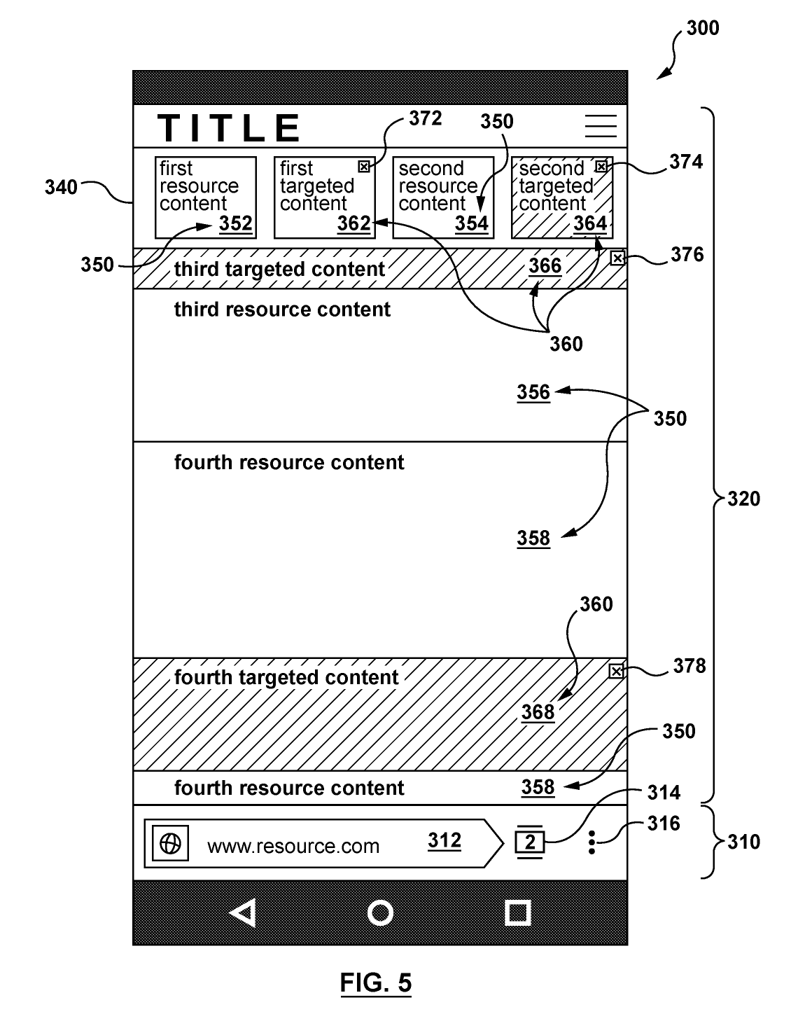

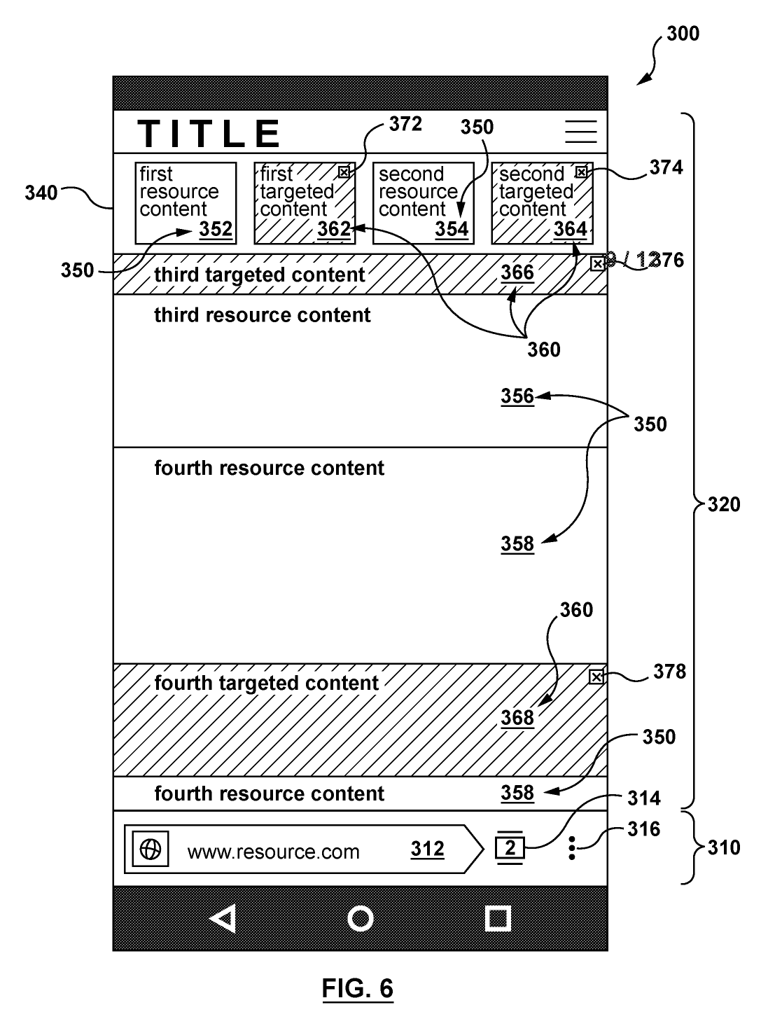

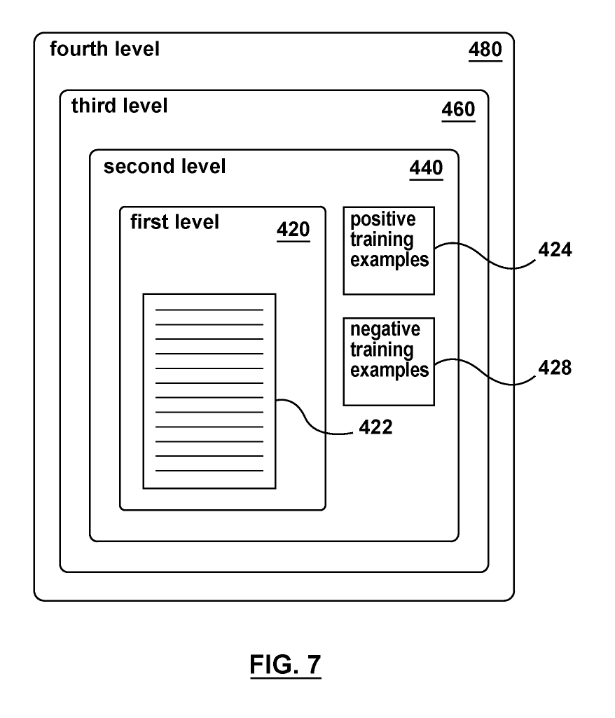

Reference is now made to FIGS. 3-7, in which the browser application 300 executing different levels of selection of targeted content is illustrated. FIG. 3, FIG. 4, FIG. 5 and FIG. 6 may represent, respectively, a first level 720, a second level 740, a third level 760 and a fourth level 780 of the selection of targeted content in accordance with embodiments of the present technology. FIG. 7 represents the first level 720, the second level 740, the third level 760 and the fourth level 780 in a single four level diagram (not separately labelled) illustrating the selection of targeted content.

The first user 203 may access the browser application 300 via a home screen (not depicted) of the first electronic device 100. The browser application 300 may be acquired from an application marketplace such as, but not limited to, the Google Play™ Store, the Amazon AppStore™ or the iOS App Store™. The browser application 300 may be a mobile web browser such as Google Chrome™, Mozilla Firefox™, Opera™, or Yandex.Browser™. In other embodiments, the browser application 300 may be another application configured to access a resource (such as Facebook™, LinkedIn™, Instagram™, Twitter™, etc.) as an example by implementing a WebView class on devices using the Android OS or UIWebView class on iOS devices.

The first user 203 may be logged on the browser application 300 with a user account (not depicted) associated with the browser application 300 or another service. In some embodiments, the first user 203 may be uniquely identified by the browser application 300 such as by a unique identifier associated with first user 203, a user agent associated with the first user 203, a user profile associated with first user 203. In other embodiments, the first user 203 may associated with a group ID by the browser application 300.

The implementation of a browser application 300 is generally known in the art. The browser application 300 may comprise a command interface 310 and a displayable area 320. The command interface 310 may comprise an omnibox 312, a first button 314 and a second button 316. The omnibox 312 may function as an address bar allowing the user to enter a uniform resource locator (URL) of a resource, or to perform a search on a search engine, such as the Yandex™ search engine, by entering queries directly in the omnibox 312. The first button 314 may be a button allowing the first user 203 to switch between tabs, each tab displaying a resource. The second button 316 may be a settings button, allowing the first user 203 to adjust different settings of the browser application 300, and select between the first level 720, the second level 740, the third level 760 and the fourth level 780 of selection of targeted content. The displayable area 320 may be an area of the browser application 300 for displaying a resource 340.

The resource 340, which may have been accessed by the first user 203 by typing an URL in the omnibox 312, may be hosted on the first server 220. The resource 340 may comprise resource content 350 and targeted content 360. The resource content 350 may comprise a first resource content 352, a second resource content 354, a third resource content 356 and a fourth resource content 358.

Each one of the first resource content 352, the second resource content 354, the third resource content 356 and the fourth resource content 358 may be content specifically related to the resource 340, which may have been accessed by the first user 203 because he was, as a non-limiting example, interested in science and technology news. As a non-limiting example, the first resource content 352 may be a news article, second resource content 354 may be another news article, third resource content 356 may be a photo of a headline article and fourth resource content 358 may be a text of the headline article.

As should be understood, in alternative embodiments, the resource 340 may be a resource that the first user 203 has accessed specifically to have targeted content recommendations. As another non-limiting example, the resource 340 may be a content aggregator, a social media network, a blog, or any other type of resource configured to provide targeted content. The resource 340 may comprise a combination of resource content 350 and targeted content 360 in various forms: text, media (such as: photos, videos, audio, animations, etc.), interactive content (such as: quiz, games, etc.). The targeted content 360 may be displayed at different locations on the resource, and may be of various size, type and content.

The targeted content 360 comprises a first targeted content 362, a second targeted content 364, a third targeted content 366 and a fourth targeted content 368, which may be in part content specifically targeted to users of the resource 340 in general or specifically targeted for the first user 203 (as an example, by way of a cookie associated with the first electronic device 100 of the first user 203, or by the first user 203 having logged on the resource 340).

As a non-limiting example, the first targeted content 362 may be an article of a partner resource hosted on second server 230 reviewing a new iPhone™ smartphone provided by the first content provider 240. The second targeted content 364 may be a recommended article about politics from a partner resource hosted on second server 230 provided by the first content provider 240. The third targeted content 366 may be an advertisement reciting “HOT SINGLES IN YOUR AREA” with a picture of a faintly dressed lady provided by the second content provider 250, and the fourth targeted content 368 may be a multicolored advertisement animation for a detergent provided by the first content provider 240.

The browser application 300 may further comprise a targeted content selector module (not depicted), which may be an extension installed by the first user 203, a different application (not depicted) on the first electronic device 100, or may be incorporated into the operating system of the first electronic device 100. The targeted content selector module may comprise four nested levels of selection of targeted content: the first level 420, the second level 440, the third level 460 and the fourth level 480, each higher level comprising the previous levels (as depicted in FIG. 7).

The targeted content selector module may add functionalities to the browser application 300 by allowing the first user 203 to interact with the targeted content and to provide explicit user feedback, as will be described in greater detail herein below. Each one of the first level 420, the second level 440, the third level 460 and the fourth level 480 may be activated by explicit user feedback, as an example by the first user 203 activating a button (such as the second button 316 of the browser application 300 or a physical button on the first electronic device 100), by a user gesture (such as a swipe, a specific swipe pattern, a long-click or touch, a force touch, multiple tap gestures, etc.).

However, the first level 420 may be generally automatically activated upon starting the browser application 300. In the embodiments illustrated herein, the targeted content selector module may insert feedback buttons on the targeted content: a first feedback button 372 on the first targeted content 362, a second feedback button 374 on the second targeted content 364, a third feedback button 376 on the third targeted content 366 and a fourth feedback button 378 on the fourth targeted content 368.

As stated previously, the first level 420 may be turned on by default upon execution of the browser application 300. The first level 420 of selection of targeted content may automatically cause the first electronic device 100 to block content from a list of blocked targeted content 422 (shown in FIG. 7). The list of blocked targeted content 422 may be located on or acquired from the selection server 260, from the first electronic device 100 or from another server (not depicted).

The list of blocked targeted 422 content may include the address of targeted content (or, more specifically, an address of a source of the targeted content) that is deemed to be inappropriate to be presented to a given user or a group of users. As should be understood, depending on the demographic profile of the first user 203, the age of the first user 203, and other information associated with the first user 203, the list of blocked targeted content 422 may vary. As an example, if the first user 203 is under the age of 15, the list of blocked targeted content 422 may comprise the following categories of resources: popups, clickunders, scams, dating, violence, nudity, and extremism. However, for an older user over the age of 21 the list of blocked targeted content may comprise only the following categories of resources: popups, clickunders, scams. In other embodiments, the first level 420 may use a DNS filter or a DNS cache.

The list of blocked targeted content 422 may contain the URLs of the resources providing targeted content and address of the networks and servers providing targeted content. In some embodiments, the list of blocked targeted content 422 may comprise a plurality of lists of blocked targeted content. Generally, the browser application 300 (or the selection server 260, acting as a proxy), upon receiving a request to access a resource (such as resource 340) by the first user 203, may verify if the requested resource is hosted on resources and/or servers (such as the first content provider 240 and the second content provider 250) that are on the list of blocked targeted content 422 and blocks communication with the resources and/or servers that are on the list of blocked targeted content 422.

The browser application 300 may also hide the targeted content via the coding of the resource if the targeted content links to resources that are part of the list of blocked targeted content 422. In some embodiments, the list of blocked targeted content 422 may also have the address of resources often visited by users, such as search engines, social media websites, shopping websites etc., with a rule to block every element in the coding of the page that contains, as an example, mention of “ads”, “partner articles”, “sponsored articles” or “recommended”. In alternative embodiments, the first level 420 may block all targeted content that does not present a valid signature (i.e. via a public key) during a request to access a resource.

With reference to FIG. 3, the targeted content 360 displayed on the resource content 350 comprises the third targeted content 366, which is an advertisement reciting “HOT SINGLES IN YOUR AREA” with a picture of a faintly dressed lady, which may be automatically blocked (hatched in the FIG. 3) because it links to a resource hosted on the second content provider 250 that is on the list of blocked targeted content 422. The third targeted content 366 may also be blocked because the second content provider 250 is part of the list of blocked targeted content 422.

The first user 203 may activate the second level 440 of selection of targeted content. The second level 440 of selection of targeted content may be activated after the first level 420 of selection of targeted content. The second level 440 of selection of targeted content may use explicit user feedback to block targeted content, as it will be explained more in detail in the following paragraphs. The second level 440 of selection of targeted content may use a machine learning algorithm trained on positive training examples 444 and negative training examples 448 (FIG. 7). Generally, the first user 203 may be able to provide explicit user feedback to block a specific targeted content, such as any of the first targeted content 362, the second targeted content 364, the third targeted content 366 and the fourth targeted content 368, displayed on a resource, such as resource 340, that he deems not relevant, inappropriate, invasive, distracting, resource-heavy, or simply wants hidden.

As described above, the explicit user feedback may take different forms: by a user actuating a button (such as the second button 316 of the browser application 300 or a physical button on the first electronic device 100), by a user gesture (such as a swipe, a specific swipe pattern, a long-click or touch, a force touch, multiple tap gestures, etc.). In this embodiment, the first user 203 may block targeted content via the first feedback button 372, the second feedback button 374, the third feedback button 376 and the fourth feedback button 378. In alternative embodiments, the first user 203 may press a button such as the second button 316 on the browser application 300 and select the unwanted targeted content.

With reference to FIG. 4, the first user 203 may decide to block the fourth targeted content 368 via the fourth feedback button 378 displayed in the upper right corner of the fourth targeted content 368, the fourth targeted content 368 being a multicolored advertisement animation for a detergent that the first user 203 may have deemed distracting when reading the text of the third resource content 356. The fourth targeted content 368 may then be blocked (thus, hatched in FIG. 4).

The blocking of the fourth targeted content 368 via the fourth feedback button 378 may hide the fourth targeted content 368 from being displayed on the resource 340 in the displayable area 320 of the browser application 300, cover the fourth targeted content 368 or replace the fourth targeted content 368 with another targeted content (not depicted). In addition to blocking the fourth targeted content 368, the browser application 300 may also provide feedback information to the selection server 260.

Generally, the explicit user feedback to activate the second level 440 to block targeted content may be instrumental in (1) removing (or otherwise blocking from being viewed) the targeted content displayed on the displayable area 320 of the browser application 300 and (2) sending a set of indications of the blocked targeted content (not depicted) to the selection server 260 to train the machine learning algorithm.

The set of indications of the targeted content may generally comprise an indication that the targeted content was blocked, and a plurality of attributes of the blocked targeted content. The set of indications may also comprise information about the resource and attributes of the resource on which the targeted content was displayed. The selection server 260 may then store the set of indications as a negative training example 448.

If the first user 203 is interested in the targeted content, the first user 203 may click on the targeted content to access a resource, thereby sending a signal to the first content provider 240 (i.e. sending another set of indications). The first content provider 240 (and/or the first electronic device 100) may save this other set of indications as a positive training example 444, the positive training example 444 representing targeted content that is not deemed undesirable by the first user 203. In other embodiments, all targeted content that has not been explicitly blocked by the first user 203 may have its set of indications stored as a positive training example 444.

The selection server 260 may then be able to train a machine learning algorithm to analyze targeted content, and classify the targeted content as a positive targeted content or a negative targeted content based on a plurality of attributes of the targeted content, as it will be explained more in detail in the following paragraphs. The second level 440 may therefore allow a user (such as first user 203) to block undesirable targeted content (such as the fourth targeted content 468) displayed in the displayable area 320 of the browser application 300 on the first electronic device 100 and provide labelled targeted content for training a machine learning algorithm on the selection server 260.

The second level 440 may be considered to be “user-specific”, in the sense that the selection server 260 may develop a specific machine learning model for each user (such as the first user 203, the second user 205 and the third user 207) depending on the targeted content that is blocked by each user. The machine learning algorithm may then analyze and block received targeted content based on the plurality of attributes of the targeted content.

Furthermore, if the selection server 260 receives a set of indications of a specific targeted content that has been blocked by a number of users that is over a predetermined threshold, the selection server 260 may cause the browser application 300 to block the specific targeted content and content with similar attributes (as determined by the MLA) for all users of the browser application 300.

The third level 460 of selection of targeted content may also be activated with explicit user feedback such as the first user 203 actuating a specific button (such as the second button 316) or by performing a specific gesture in the browser application 300, which may trigger the third level 460 for blocking targeted content. The third level 460 may be activated after the second level 440 of selection of targeted content. As should be understood, the third level 460 includes the second level 440.

The third level 460 may allow detecting negative or undesirable targeted content without explicit user feedback on the targeted content, and blocking the rendering of negative targeted content in the displayable area 320 of the browser application 300. The browser application 300 may analyze the targeted content 360 and apply a set of heuristics (or other type of rules) to verify if the attributes of the targeted content include at least one of a predetermined criterion: presence of sound, overlapping or obstructing resource content, inserted in the middle of important content (i.e. in the middle of text of an article), covers more than 20% of the screen, or originates from a potentially negative advertisement server.

In some embodiments, the set of heuristics may be based on the machine learning algorithm. Additionally, the browser application 300 may add to the HTTP header, during a request, an instruction to a requested resource to provide only targeted content that does not match the predetermined criteria or the received targeted content will be blocked from being displayed on the requested resource. In alternative embodiments, the third level 460 may be executed before the second level 440.

With reference to FIG. 5, the activation of the third level 460 of selection of targeted content may cause the browser application 300 to block the second targeted content 364 (hatched in FIG. 5), with the third targeted content 366 and the fourth targeted content 368 already having been blocked on the first level 420 and the second level 440 of selection of targeted content. The browser application 300 may have blocked the second targeted content 364 because the video was auto playing and had presence of sound on loading of the resource 340, therefore not respecting at least one predetermined criterion.

The fourth level 480 of selection of targeted content may also be activated with explicit user feedback such as the first user 203 pressing a specific button (such as the second button 316) or by performing a specific gesture in the browser application 300, which may trigger the fourth level 480 for blocking all targeted content. The fourth level 480 may cause the browser application 300 to block all targeted content, positive and negative targeted content, from a resource.

With reference to FIG. 6, the activation of the fourth level 480 of selection of targeted content may cause the browser application 300 to block the first targeted content 362, with the second targeted content 364, the third targeted content 366 and the fourth targeted content 368 having been already blocked previously by the first level 420, the second level 440 and the third level 460 of selection of targeted content. The fourth level 480 of selection of targeted content may use the same or different mechanisms, as those described in relation to the first level 420, the second level 440 and the third level 460.

Furthermore, the information about the blocked targeted content and the plurality of attributes of the targeted content that has been determined to be a negative targeted content by the MLA or blocked by users may be sent as feedback to the targeted content providers or resources, therefore allowing improving the quality of the targeted content that will be presented to users.

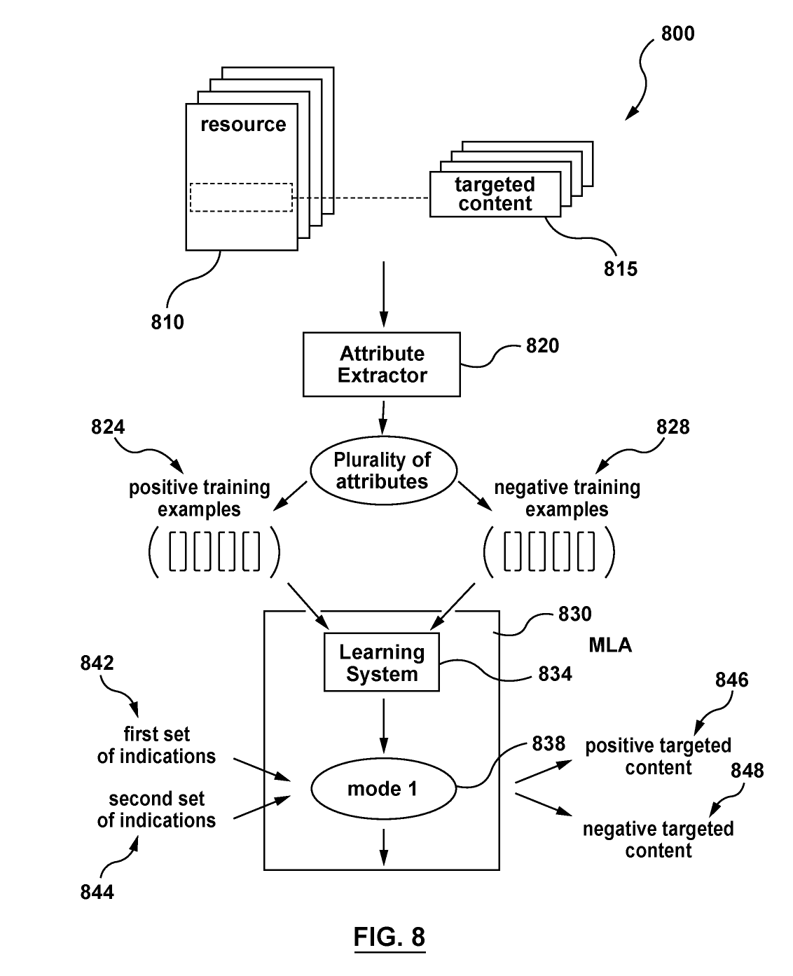

With the different levels of selection of targeted content having been described from the perspective of the first user 203 operating the browser application 300 on the first electronic device 100, a more detailed explanation of the machine learning algorithm that may be implemented in part on the selection server 260 and an electronic device (such as the first electronic device 100) will be provided in FIG. 8.

With reference to FIG. 8, a machine learning component 800 for the selection of targeted content is illustrated as implemented in accordance with embodiments of the present technology. The machine learning component 800 may comprise an attribute extractor 820, and a machine learning algorithm 830.

The attribute extractor 820 may be implemented and executed by each one of the plurality of electronic devices 210 (i.e. the first electronic device 100, the second electronic device 215 and the third electronic device 217). In alternative embodiments, the attribute extractor 820 may be implemented and executed directly on the selection server 260, therefore saving resources (computing time, power, battery) on the plurality of electronic devices 210.

The machine learning algorithm 830 comprises a learning system 834 and a model 838 and may be implemented and executed on the selection server 260. However, in alternative embodiments, the machine learning algorithm 830 comprising the learning system 834 and the model 838 may be implemented and executed on each one of the plurality of electronic devices 210 comprising the first electronic device 100, the second electronic device 215 and the third electronic device 217, therefore providing privacy and a personalized method for selecting targeted content.

The attribute extractor 820 may be configured to extract attributes from the resource 340 and the targeted content 360 displayed on or with the resource 340 by receiving the resource 340 comprising the targeted content 360 as an input and outputting a plurality of attributes 822. The attribute extractor 820 may be part of the browser application 300 on an electronic device such as the first electronic device 100, the second electronic device 215 and the third electronic device 217, or may be directly implemented on the selection server 260. The attribute extractor may also be implemented on the first content provider 240, which may provide the targeted content that will be used as positive training examples.

The attribute extractor 820 may be configured to extract attributes upon receiving a trigger signal from a user via the browser application 300, such as the first user 203 providing explicit user feedback to block the fourth targeted content 368 by clicking on the fourth targeted content 368.

In alternative embodiments, where the attribute extractor 820 is implemented on an electronic device, the attribute extractor 820 may extract attributes every time a resource loads, but may only send a plurality of attributes upon receiving an explicit user feedback for blocking targeted content.

Generally, the attribute extractor 820 may parse the source code of a resource such as the resource 340 containing the targeted content 360 to extract a plurality of attributes.

As a non-limiting example, the attribute extractor 820 may be implemented in a programming or scripting language such as, but not limited to, JavaScript, PHP, Perl, TCL or Python. The attribute extractor 820 may as an example parse at least one of the HTML source code, the cascade-styling sheet (CSS) files, the javascript files and/or the document object model (DOM) of the resource 340 to first detect the targeted content 370 and its associated resource(s). As an example, the targeted content 370 may be associated with a particular element, attribute, style, text, class in the source code of the resource 340. Next, the attribute extractor 820 may extract a plurality of attributes from the targeted content 370, which may be represented, as a non-limiting example, in the form of a vector or array.

As such, the attribute extractor 820 may extract visual attributes (background color, text color, elements color, shading, etc.), structural attributes (positioning of elements, size of elements, presence of overlap, hierarchy of the elements, etc.) and content attributes (title, section titles, text, keywords, links to other resources, speed of animation/video, presence of sound, etc.) from the targeted content 360. In some embodiments, the attribute extractor 820 may also extract visual attributes, structural attributes and content attributes from the resource 340. As should be understood, only a subset of all of the attributes may be extracted from the resource 340 and the targeted content 360.

In embodiments where the attribute extractor 820 is implemented on an electronic device, the plurality of attributes 822 may be saved locally on the respective electronic device (i.e. first electronic device 100) before being sent to the selection server 260.

The plurality of attributes 822 may be divided and stored (i.e. in a memory of the selection server 260) as positive training examples 824 and negative training examples 828. As should be understood, the plurality of attributes 822 may be automatically marked (based, for example, on how they were generated in the first place) as being a negative training example or a positive training example when it is extracted from the resources 810 and targeted content 815 by the attribute extractor 820.

The positive training examples 824 and the negative training examples 828 may be retrieved and sent to the machine learning algorithm 830, the machine learning algorithm 830 comprising the learning system 834 and the model 838. In some embodiments, the negative training examples 828 for a particular targeted content may only be sent to the machine learning algorithm 830 if a predetermined threshold number of indications for blocking the particular targeted content have been received from a predetermined number of users.

The learning system 834 may take as an input the positive training examples 824 and the negative training examples 828 to output the model 838. The goal of the learning system 834 may be to create the model 838 or rule based on the positive training examples (comprising targeted content that has not been blocked by a given user and/or a subset of users and/or any user) and the negative training examples 828 (comprising the blocked targeted content by any given user), the model 838 for making predictions on the type of targeted content based on the plurality of attributes 822 of the targeted content.

The learning system 834 may generally consider at least one of the visual attributes (background color, text color, elements color, shading, screenshot, etc.), structural attributes (positioning of elements, size of elements, presence of overlap, hierarchy of the elements, etc.) and content attributes (title, section titles, text, keywords, address, etc.) of the targeted content. The learning system 834 may also consider the visual attributes, the structural attributes and the content attributes of the resources 810 where the targeted content 815 is displayed. In some embodiments, the learning system 834 may match respectively the attributes of the targeted content 815 and the attributes of the resources 810 where the targeted content 815 is displayed when generating the model 838 based on the positive training examples 824 and the negative training examples 828.

As a non-limiting example, the learning system 834 may consider the respective colors of the targeted content and the resource to see if the respective colors blend, are complementary or if there is a contrast. As another non-limiting example, the learning system 834 may also consider the respective contents of the resource and the targeted content. The learning system 834 may further consider the attributes of the plurality of users 201 viewing the targeted content, such as age, gender, social media account information, demographic information, past browsing history etc. The learning system 834 may also consider the attributes of the plurality of electronic devices 210 associated with the plurality of users 201, such as manufacturer, model, resolution, IP address, cookies, and other device-related properties.

The MLA 830 may then be ready to determine the type of the targeted content using the model 838. By receiving, as an example, a first set of indications 842 and a second set of indications 844, the MLA 830 may determine if the type of the targeted content is a positive targeted content 846 or a negative targeted content 848.

Referring again to the example of FIG. 4, where the first user 203 has blocked the fourth targeted content 368 via the fourth feedback button 378 because the fourth targeted content 368 was obstructing in part the text of the fourth resource content 358, The learning system 834 may analyze the plurality of attributes of the fourth targeted content 368 and the resource 340, and make a rule with model 838 where targeted content that has at least 3 colors, is animated and is displayed on a mainly black and white page with at least 80% text content is classified as being a negative targeted content.

As should be understood, these are illustrative non-limiting examples and the learning system 834 may function differently. The learning system 834 may use decision trees, boosting, support-vector machines (SVM), neural networks, nearest neighbor algorithms, Naive Bayes, bagging and random forests among others. As it may also be understood, the accuracy of the model 838 may be improved over time by continuous training with the positive training examples 824 and the negative training examples 828 that are received.

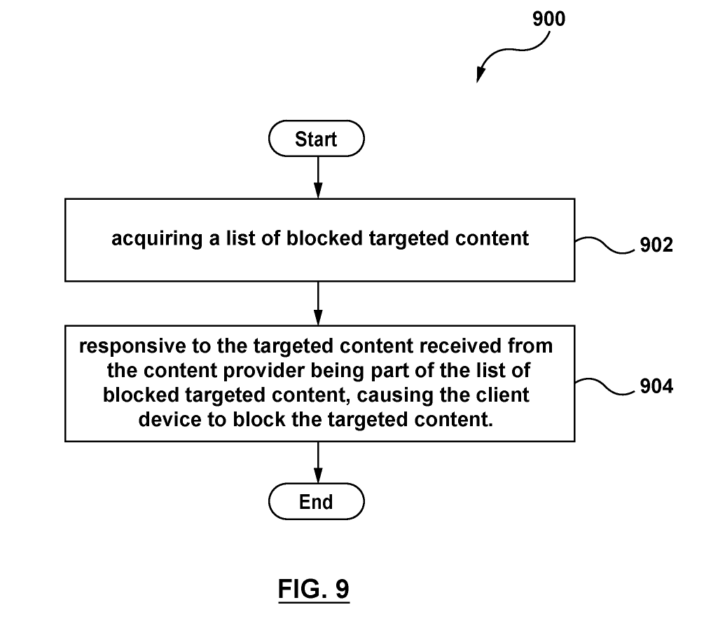

Having described, with reference to FIG. 1 to FIG. 8, some non-limiting example instances of systems and computer-implemented methods used in connection with the problem of selecting targeted content, we shall now describe computer-implemented methods associated with the selection of targeted content, with reference to FIG. 9 to FIG. 12.

More specifically, FIG. 9 shows a flowchart illustrating a first computer-implemented method 900 executed on the selection server 260. The method 900 may correspond to the first level 720 of selection of targeted content. In some embodiments, the method 900 may be entirely executed on the first electronic device 100 instead of the selection server 260.

The method may start at step 902.

STEP 902: acquiring a list of blocked targeted content

At a step 902, the selection server 260 acquires a list of blocked targeted content 422 from a database or from another server (not depicted), the list of blocked targeted content 422 comprising a list of resources and servers providing targeted content that is deemed to be inappropriate. The method may then advance at step 904.

STEP 904: responsive to a targeted content received from the content provider being part of the list of blocked targeted content, causing the electronic device to block the targeted content

At a step 904, responsive to a targeted content received from the first content provider 240, the first content provider 240 being part of the list of blocked targeted content 422, the selection server 260 may cause the first electronic device 100 to block the targeted content.

As explained above, the browser application 300 (or the selection server 260, acting as a proxy), upon receiving a request to access a resource (such as resource 340) by the first user 203, may verify if the request to access a resource requests targeted content hosted on resources and/or servers (such as the first content provider 240 and the second content provider 250) that are on the list of blocked targeted content 422 and blocks communication with the resources and/or servers that are on the list of blocked targeted content 422.

The browser application 300 may also hide the targeted content via the coding of the resource if the targeted content originates from resources part of the list of blocked targeted content 422.

The method 900 may then end.

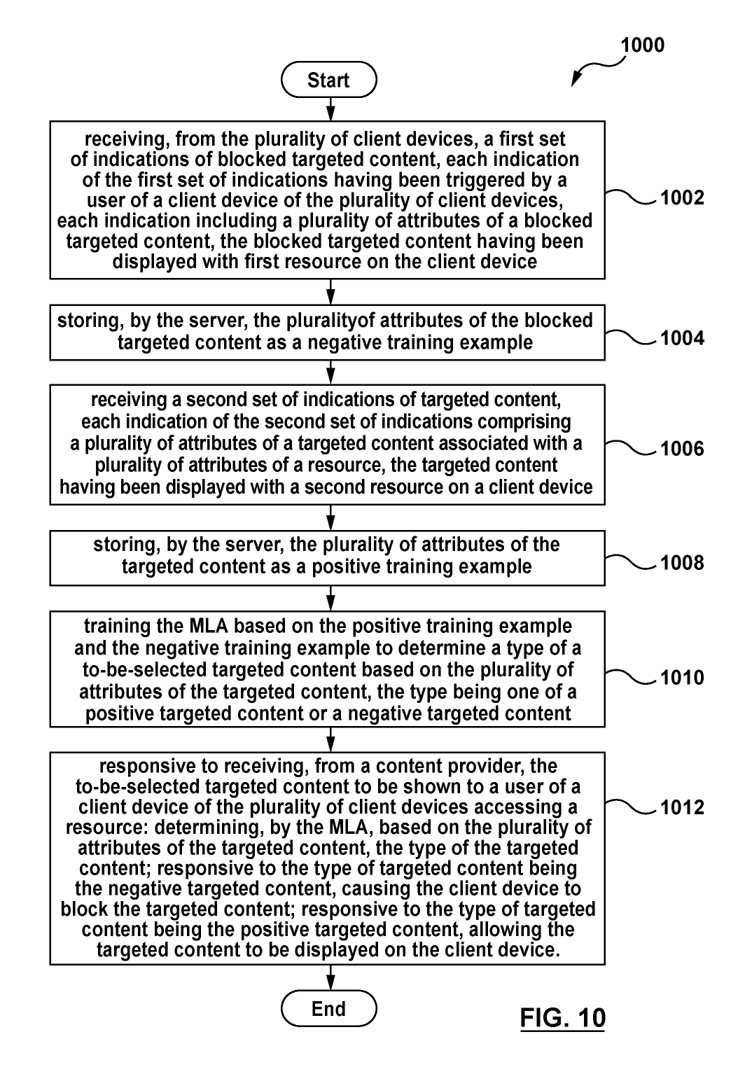

Turning now to FIG. 10, there is shown a flowchart illustrating a second computer-implemented method 1000 executed on the selection server 260. The method 1000 may correspond to the second level 740 of selection of targeted content. As should be understood from the previous examples, the method 1000 may be executed when explicit feedback is provided by a user, which may happen directly after method 900 or at a different time or a different browsing session.

The method may start at step 1002.

STEP 1002: receiving, from the plurality of electronic devices 210, a first set of indications of blocked targeted content, each indication of the first set of indications having been triggered by a user of a electronic device of the plurality of electronic devices, each indication including a plurality of attributes of a blocked targeted content, the blocked targeted content having been displayed with a resource on the electronic device

At a step 1002, the selection server 260 may receive from some or all of the plurality of electronic devices 210 (i.e. the first electronic device 100, the second electronic device 215 and the third electronic device 217), a first set of indications 844 of the fourth targeted content 368, each indication of the first set of indications 844 having been triggered respectively by the first user 203, the second user 205 and the third user 207 of the plurality of users 201, each indication including a plurality of attributes of the fourth targeted content 368, the blocked targeted content having been displayed with the resource 340 on the first electronic device 100, the second electronic device 215 and the third electronic device 217.

As should be understood, the first set of indications 842 may not necessarily be for the same blocked targeted content and/or the same resource on which the blocked targeted content was displayed on.

The method may then advance at step 1004.

STEP 1004: storing, by the server, the plurality of attributes of the blocked targeted content as a negative training example

At a step 1004, the selection server 260 may store the plurality of attributes 822 of the fourth targeted content 368 displayed on the resource 340 as a negative training example.

STEP 1006: receiving a second set of indications of targeted content, each indication of the second set of indications comprising a plurality of attributes of a targeted content, the targeted content having been displayed with a resource on a electronic device

At a step 1006, the selection server 260 may receive a second set of indications 844 of targeted content, each indication of the second set of indications 844 comprising a plurality of attributes of a targeted content associated with a plurality of attributes of a resource 340, the first targeted content 362 having been displayed with the resource on a electronic device (displayed and not blocked as described above).

As should be understood, the second set of indications 844 may not necessarily be for the same targeted content and/or the same resource on which the targeted content was displayed on. The second set of indications 844 may be received from the electronic device (such as the plurality of electronic devices 210) or from the first content provider 240 or the second content provider 250.

The method may then advance to step 1108.

STEP 1008: storing, by the server, the plurality of attributes of the targeted content as a positive training example

At a step 1008, the selection server 260 may store the plurality of attributes of the targeted content as a positive training example 824.

The method may then advance to step 1010.

STEP 1010: training the MLA based on the positive training example and the negative training example to determine a type of a to-be-selected targeted content based on the plurality of attributes of the targeted content, the type being one of a positive targeted content or a negative targeted content

At a step 1010, the selection server 260 may train the MLA 830 based on the positive training example 824 and the negative training example 8282 to determine a type of a to-be-selected targeted content based on the plurality of attributes of the targeted content, the type being one of a positive targeted content 846 or a negative targeted content 848.

The method may then advance to step 112.

STEP 1012: responsive to receiving, from a content provider, the to-be-selected targeted content to be shown to a user of a electronic device of the plurality of electronic devices accessing a resource: determining, by the MLA, based on the plurality of attributes of the targeted content, the type of the targeted content; responsive to the type of targeted content being the negative targeted content, causing the electronic device to block the targeted content; responsive to the type of targeted content being the positive targeted content, allowing the targeted content to be displayed on the electronic device

At a step 1012, the selection server 260, responsive to receiving, from the second content provider 250, the to-be-selected targeted content to be shown to a first user 203 of an first electronic device 100 of the plurality of electronic devices 210 accessing a resource 340: determining, by the MLA 830, based on the plurality of attributes 822 of the to-be-selected targeted content, the type of the targeted content; responsive to the type of targeted content being the negative targeted content 848, causing the first electronic device 100 to block the targeted content; responsive to the type of targeted content being the positive targeted content, allowing the targeted content to be displayed on the first electronic device 100.

The method 1000 may then end.

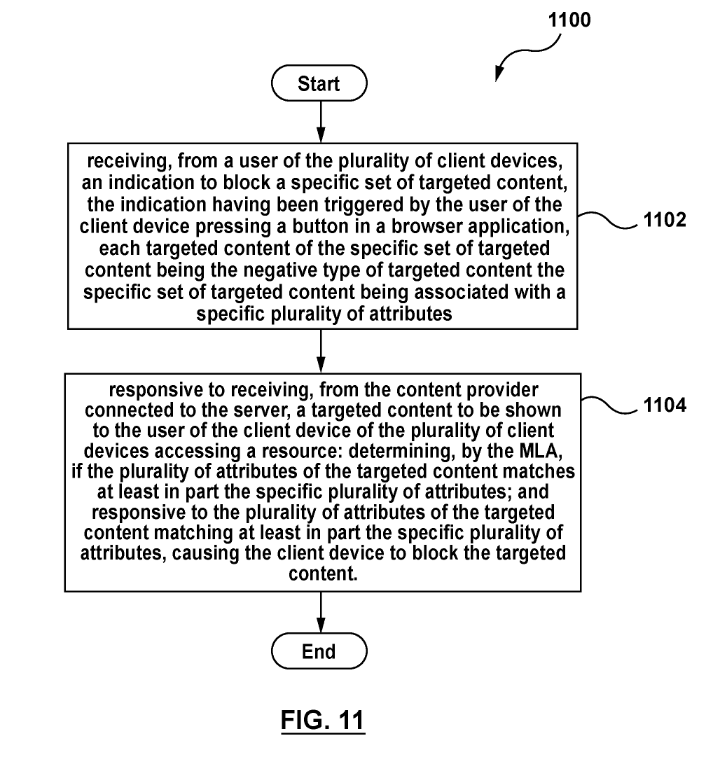

Turning now to FIG. 11, there is shown a flowchart illustrating a third computer-implemented method 1100 executed on the selection server 260. The method 1100 may correspond to the third level 760 of selection of targeted content. As should be understood from the previous examples, the method 1100 may be executed when explicit feedback is provided by a user, which may happen directly after method 1000 or at a different time or a different browsing session.

The method may start a step 1102.

STEP 1102: receiving, from a user of the plurality of electronic devices, an indication to block a specific set of targeted content, the indication having been triggered by the user of the electronic device pressing a button in a browser application, the specific set of targeted content being associated with a specific plurality of attributes

At a step 1102, the selection server 260 may receive, from a user of the plurality of electronic devices 210, an indication to block a specific set of targeted content, the indication having been triggered by the first user 203 of the first electronic device 100 pressing a button in a browser application 300, the specific set of targeted content being associated with a specific plurality of attributes.

The method may then advance to step 1104.

STEP 1104: responsive to receiving, from the content provider connected to the server, a targeted content to be shown to the user of the electronic device of the plurality of electronic devices accessing a resource: determining if the plurality of attributes of the targeted content matches at least in part the specific plurality of attributes; and responsive to the plurality of attributes of the targeted content matching at least in part the specific plurality of attributes, causing the electronic device to block the targeted content

At a step 1104, the selection server 260 may, in response to receiving, from the first content provider 240 connected to the server, a targeted content to be shown to the first user 203 of the first electronic device 100 of the plurality of electronic devices 210 accessing a resource: determining if the plurality of attributes of the targeted content matches at least in part the specific plurality of attributes and responsive to the plurality of attributes of the targeted content matching at least in part the specific plurality of attributes, causing the first electronic device 100 to block the targeted content. The selection server 260 or the browser application 300 may apply a set of heuristics to verify if the attributes of the targeted content include at least one of a predetermined criterion or specific plurality of attributes: presence of sound, overlapping or obstructing resource content, inserted in the middle of content (i.e. inside the text of an article), covers more than 20% of the screen, or originates from a potentially negative advertisement server. If the targeted content has at least one of the specific plurality of attributes, the targeted content may be blocked.

The method 1100 may then end.

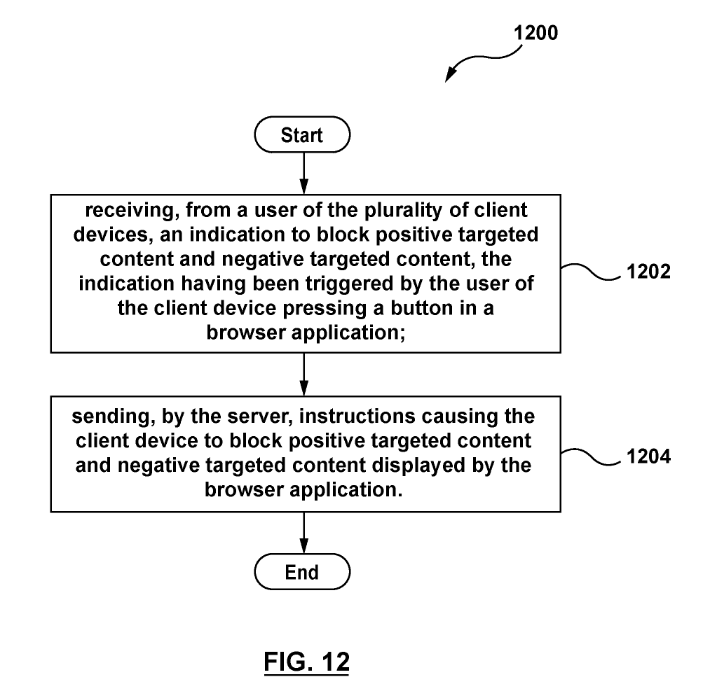

Turning now to FIG. 12, there is shown a flowchart illustrating a fourth computer-implemented method 1200 executed on the selection server 260. The method 1200 may correspond to the fourth level 780 of selection of targeted content.

STEP 1202: receiving, from a user of the plurality of electronic devices, an indication to block all targeted content, the indication having been triggered by the user of the electronic device pressing a button in a browser application

At a step 1202, the selection server 260 may receive, from a first user 203 of the plurality of electronic devices 210, an indication to block the positive targeted content 846 and negative targeted content 848, the indication having been triggered by the first user 203 of the electronic device pressing a button in a browser application 300. The method 1200 may then advance to step 1204. As should be understood, the indication may be to block all targeted content. The method may advance to step 1204.

STEP 1204: sending, by the server, instructions causing the electronic device to block all targeted content displayed by the browser application.

At a step 1204, the selection server 260 may send instructions causing the first electronic device 100 to block the positive targeted content 846 and negative targeted content 848 displayed by the browser application 300.

The method 1200 may then end.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

Within the present description it should be understood that in any case where retrieving data from any electronic device and/or from any mail server is mentioned, retrieving an electronic or other signal from corresponding electronic device (a server, a mail server) can be used, and displaying on a screen of the device can be implemented as transmitting a signal to the screen, the signal includes specific information which further can be interpreted with specific images and at least partially displayed on the screen of the electronic device. Sending and receiving the signal is not mentioned in some cases within the present description to simplify the description and as an aid to understanding. Signals can be transmitted using optical methods (for example, using fiber-optic communication), electronic methods (wired or wireless communication), mechanic methods (transmitting pressure, temperature and/or other physical parameters by the means of which transmitting a signal is possible.

1. A computer-implemented method for selecting targeted content by a machine learning algorithm (MLA), the method executable on a server, the server connectable to a plurality of electronic devices via a communication network, the method comprising:
receiving, from the plurality of electronic devices, a first set of indications of blocked targeted content, each indication of the first set of indications having been triggered by a user of a electronic device of the plurality of electronic devices, each indication including a plurality of attributes of a blocked targeted content, the blocked targeted content having been displayed with a first resource on the electronic device;
storing, by the server, the plurality of attributes of the blocked targeted content as a negative training example;
receiving a second set of indications of targeted content, each indication of the second set of indications comprising a plurality of attributes of a targeted content, the targeted content having been displayed with a second resource on a electronic device;
storing, by the server, the plurality of attributes of the targeted content as a positive training example;
training the MLA based on the positive training example and the negative training example to determine a type of a to-be-selected targeted content based on the plurality of attributes of the targeted content, the type being one of a positive targeted content or a negative targeted content;
responsive to receiving, from a content provider, the to-be-selected targeted content to be shown to a user of a electronic device of the plurality of electronic devices accessing a resource:
determining, by the MLA, based on the plurality of attributes of the targeted content, the type of the targeted content; and
responsive to the type of targeted content being the negative targeted content, causing the electronic device to block the targeted content.

2. The method of claim 1, further comprising:
responsive to the type of targeted content being the positive targeted content, allowing the targeted content to be displayed on the electronic device.

3. The method of claim 1, wherein each indication of the first set of indications of blocked targeted content and each indication of the second set of indications of targeted content further comprises respectively a plurality of attributes of the first resource and the second resource with which the targeted content was displayed with, wherein the storing comprises storing the plurality of attributes of the first resource and the second resource and wherein the training and the determining are further based on the plurality of attributes of the first resource and the second resource.

4. The method of claim 1, wherein the plurality of attributes of the targeted content being stored as a positive training example is the plurality of attributes of targeted content not having been blocked by a user accessing the second resource.

5. The method of claim 1, wherein each indication of the first set of indications of blocked targeted content and each indication of the second set of indications of targeted content further comprises a plurality of attributes of the respective user, and wherein the training and the determining are further based on the plurality of attributes of the respective user.

6. The method of claim 5, wherein the second set of indications of targeted content is received from the content provider.

7. The method of claim 5, wherein the second set of indications of targeted content is received from the plurality of electronic devices.

8. The method of claim 1, wherein each indication of the first set of indications of blocked targeted content and each indication of the second set of indications of targeted content further comprises a plurality of attributes of the respective electronic device, and wherein the training and the determining are further based on the plurality of attributes of the respective electronic device.

9. The method of claim 1, wherein each indication has been triggered by the user of the electronic device pressing a button in a browser application of the electronic device to block targeted content.

10. The method of claim 1, wherein the plurality of attributes of the targeted content and the plurality of attributes of the blocked targeted content comprise at least one of: a size of the targeted content, a location of the targeted content on the resource, a source associated with the targeted content, a presence of audio in the targeted content, a presence of animations in the targeted content, a HTML attribute of the targeted content.

11. The method of claim 1, wherein the plurality of attributes of the resource comprises at least one of: a uniform resource locator (URL) of the resource, a title of the resource, a text of the resource, a HTML attribute of the resource, a screenshot of the resource.

12. The method of claim 1, wherein the plurality of attributes of the user comprises at least one of: a unique identifier associated with the user of the electronic device, a user agent associated with the user of the electronic device, a user profile associated with the user of the electronic device.

13. The method of claim 1, wherein the plurality of attributes of the electronic device comprises at least one of: an IP address of the electronic device, an identifier associated with the electronic device, properties of the electronic device, a cookie located on the electronic device.

14. The method of claim 1, wherein after training the MLA based on the positive training example and the negative training example to determine the type of the targeted content, the method further comprises sending, to each electronic device of the plurality of electronic devices the MLA, and wherein the receiving, the determining and the causing the electronic device to block the targeted content are executed on the electronic device.

15. The method of claim 1, wherein the training the MLA to determine the type of the targeted content comprises comparing the plurality of attributes of the targeted content and the associated plurality of attributes of the resource.

16. The method of claim 1, wherein prior to the determining by the MLA the type of the targeted content, the method further comprises:
acquiring a list of blocked targeted content;
responsive to the targeted content received from the content provider being part of the list of blocked targeted content, causing the electronic device to block the targeted content.

17. The method of claim 1, wherein the list of blocked targeted content is received from at least one of:
the electronic device; and
a database located on the server.

18. The method of claim 1, further comprising:
receiving, from a user of the plurality of electronic devices, an indication to block a specific set of targeted content, the indication having been triggered by the user of the electronic device pressing a button in a browser application, the specific set of targeted content being associated with a specific plurality of attributes;
responsive to receiving, from the content provider connected to the server, a targeted content to be shown to the user of the electronic device of the plurality of electronic devices accessing a resource:
determining if the plurality of attributes of the targeted content matches at least in part the specific plurality of attributes; and
responsive to the plurality of attributes of the targeted content matching at least in part the specific plurality of attributes, causing the electronic device to block the targeted content.

19. The method of claim 1, further comprising:
receiving, from a user of the plurality of electronic devices, an indication to block all targeted content, the indication having been triggered by the user of the electronic device pressing a button in a browser application; and
sending, by the server, instructions causing the electronic device to block a targeted content displayed by the browser application.

20. A system for selecting targeted content by a machine learning algorithm (MLA), the system connected to a plurality of electronic devices via a communication network, the system comprising:
a processor;
a non-transitory computer-readable medium comprising instructions, upon executing the instructions being configured to cause the processor to execute:
receiving, from the plurality of electronic devices, a first set of indications of blocked targeted content, each indication of the first set of indications having been triggered by a user of an electronic device of the plurality of electronic devices, each indication including a plurality of attributes of a blocked targeted content, the blocked targeted content having been displayed with a first resource on the electronic device;
storing the plurality of attributes of the blocked targeted content as a negative training example;
receiving a second set of indications of targeted content, each indication of the second set of indications comprising a plurality of attributes of a targeted content, the targeted content having been displayed with a second resource on a electronic device;
storing the plurality of attributes of the targeted content as a positive training example;
training the MLA based on the positive training example and the negative training example to determine a type of a to-be-selected targeted content based on the plurality of attributes of the targeted content, the type being one of a positive targeted content or a negative targeted content;
responsive to receiving, from a content provider, the to-be-selected targeted content to be shown to a user of a electronic device of the plurality of electronic devices accessing a resource:
determining, by the MLA, based on the plurality of attributes of the targeted content, the type of the targeted content; and
responsive to the type of targeted content being the negative targeted content, causing the electronic device to block the targeted content.
